(19) United States
(12) Patent Application Publication
(10) Pub. No.: US 2022/0385051 A1
(43) Pub. Date: Dec. 1, 2022

(54) DRAIN COUPLING FOR ELECTRICAL CONDUITS

(71) Applicant: MICHAEL FAULKENBURG, FERDINAND, IN (US)

(72) Inventor: MICHAEL FAULKENBURG, FERDINAND, IN (US)

(21) Appl. No.: 17/748,457

(22) Filed: May 19, 2022

Related U.S. Application Data
(60) Provisional application No. 63/193,652, filed on May 27, 2021.

(51) Int. Cl. H02G 3/06; H02G 3/04; F16L 41/02; F16L 55/07

(52) U.S. Cl. CPC H02G 3/06; H02G 3/0481; F16L 41/021; F16L 55/07

(57) ABSTRACT

A drain coupling adapted to connect to two electrical conduits to facilitate a drainage of condensate formed inside the electrical conduits is provided. The drain coupling comprises a tubular portion defining an elongated channel and having a first end defining a first opening adapted to connect to a first electrical conduit, and a second end arranged opposite to the first end and defining a second opening adapted to connect to a second electrical conduit. A drain tube is arranged substantially centrally to the tubular portion and extending substantially perpendicularly to the tubular portion. The drain tube includes an inlet opening at an interface of the tubular portion and an outlet opening at a second free end of the drain tube, thereby facilitating a fluid connection of a drain passage of the drain tube with the elongated channel. A guard is arranged inside the tubular portion and partially covering the inlet opening of the drain tube. The guard may be positioned at an interface of the drain tube with the tubular portion and covering the inlet opening.

### BACKGROUND OF THE INVENTION

### Field of the Invention

The present invention relates, generally, to a drain coupling for an electrical conduit system. More particularly, the present invention pertains to a drain coupling adapted to connect to electrical conduits through which electrical cables extend to facilitate a removal of condensates from the electrical conduits.

### Description of the Related Art

Electrical raceway systems having tubing, conduit, and/or fittings are generally used to provide a clear, protected pathway for electrical wiring/cables. However, even in relatively dry locations, condensation may occur on the interior walls of the raceway due to moisture in the air. The accumulation of condensate inside the electrical raceways may cause electrical short circuit and may damage electrical devices, which is undesirable.

A condulet T-fitting 10, shown in FIG. 1, is typically used for connecting three lengths of electrical conduit extending in different directions and joining together wires running through those different conduits. In addition, installers use the condulet T-fitting 10 to coaxially connect two electrical conduits while using the offset opening as a drain for removing condensate from the electrical conduits. As shown, when used as a conduit drain, the condulet T-fitting 10 includes a first conduit portion 20 defining a passageway 22 through which the electrical wiring or fish tape 24 extends from one electrical conduit to another electrical conduit, and a second conduit portion 30 arranged substantially perpendicularly to the first conduit portion 20 and defines an inlet opening at an interface of the first conduit portion 20 and the second conduit portion 30. A drain plug 40 and a breather plug 50 is inserted inside the second conduit portion 30 to enable the drainage of the condensate from the T-fitting 10. Further, the condulet T-fitting 10 includes covers 52, 54 providing an access to interior of the first conduit portion 20 to facilitate installation of electrical wires and splicing of the electrical wires. However, during installation, the fish tapes and/or the electrical wires may get stuck inside the inlet opening of the second conduit portion 30 and/or on the shoulders 62, 64 of the first conduit portion 20 to which the covers 52, 54 are connected. To release the stuck electrical wires, the covers 52, 54 needs to be disassembled in the middle of wire push, which is undesirable.

### SUMMARY OF THE INVENTION

It is therefore an object of the present invention to provide a drainage device that facilitates a drainage of the condensate from the electrical conduits or raceways without providing any obstacles to electrical wires and/or fish tape during installation of electrical wires.

It is also an object of the invention to provide a drainage device that is simple in construction and easy to assemble with the electrical conduits.

The present invention meets these objects by providing a drain coupling having a guard that prevents an entry of the electrical wires or fish tapes inside a drain passage during installation of the electrical wires.

According to an aspect, the drain coupling includes a tubular portion defining elongated channel through which the electrical wires or the fish tape extends, and a drain tube connected to the tubular portion and extending substantially perpendicularly to the tubular portion. The drain tube defines an inlet opening at the interface of the drain tube with the tubular portion to enable an entry of the condensate inside the drain tube from the elongated channel. Additionally, the drain coupling includes a guard arranged inside the tubular portion and covering the inlet opening and including a plurality of strips extending along a length of the tubular portion. The plurality of strips is arranged spaced apart from each other defining a plurality of grooves therebetween.

In an embodiment, the plurality of strips is arranged such that an upper surface of each strip is flush with an inner surface of the tubular portion.

According to one aspect of the present invention, there is provided a drain coupling adapted to connect to two electrical conduits to facilitate a drainage of condensate formed inside the electrical conduits. The drain coupling comprises a tubular portion defining an elongated channel and having a first end defining a first opening adapted to connect to a first electrical conduit, and a second end arranged opposite to the first end and defining a second opening adapted to connect to a second electrical conduit. A drain tube is arranged substantially centrally to the tubular portion and extending substantially perpendicularly to the tubular portion. The drain tube includes an inlet opening at an interface of the tubular portion and an outlet opening at a second free end of the drain tube, thereby facilitating a fluid connection of a drain passage of the drain tube with the elongated channel. A guard is arranged inside the tubular portion and partially covering the inlet opening of the drain tube. The guard may be positioned at an interface of the drain tube with the tubular portion and covering the inlet opening.

According to a further aspect of the invention, the guard may further comprise a plurality of elongated strips arranged spaced apart from each other and extending in a direction substantially parallel to a central axis of the tubular portion. Each elongated strip extends along a length of the tubular portion. An inlet groove is positioned between each pair of adjacent elongated strips. The strips are positioned at an interface of the drain tube with the tubular portion and cover the inlet opening. An upper surface of each strip is flush with the adjacently arranged portion of the inner surface of the tubular portion. A distance between adjacent strips is selected to prevent an electrical wire or fish tape from entering the drain tube through the grooves.

According to a further aspect of the invention, the guard comprises a hole located near the center of the guard. The hole is preferably in the range of approximately ¼ inch in diameter.

According to yet a further aspect of the invention, the guard comprises a plurality of holes in the guard. Each of the plurality of holes is preferably in the range of approximately ⅛ inch in diameter.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 illustrates an exploded view of a T-fitting as is known in the prior art;

FIG. 2 illustrates a top view of a drain coupling, in accordance with an embodiment of the present invention;

FIG. 3 illustrates a perspective view of the drain coupling, in accordance with an embodiment of the present invention;

FIG. 4 illustrates a inside view of the drain coupling depicting a guard arranged at an inlet opening of a drain passage of the drain coupling, in accordance with an embodiment of the present invention;

FIG. 5 illustrates a top view of a section of the drain coupling showing a plurality of strips of the guard, in accordance with the embodiment of the present invention shown in FIG. 4;

FIG. 6 illustrates a inside view of the drain coupling depicting a drain arranged at an inlet opening of a drain passage of the drain coupling, in accordance with an alternative embodiment of the present invention;

FIG. 7 illustrates a top view of a section of the drain coupling showing a single drain hole in accordance with the alternative embodiment of the present invention shown in FIG. 6;

FIG. 8 illustrates a inside view of the drain coupling depicting a drain arranged at an inlet opening of a drain passage of the drain coupling, in accordance with a further alternative embodiment of the present invention; and

FIG. 9 illustrates a top view of a section of the drain coupling showing a plurality of drain holes, in accordance with the further alternative embodiment of the present invention shown in FIG. 8.

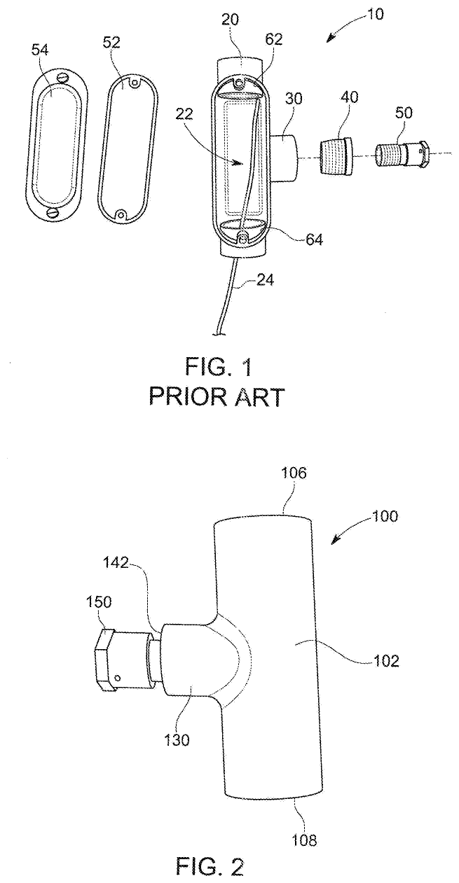

### DETAILED DESCRIPTION OF THE INVENTION

For purposes of promoting an understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

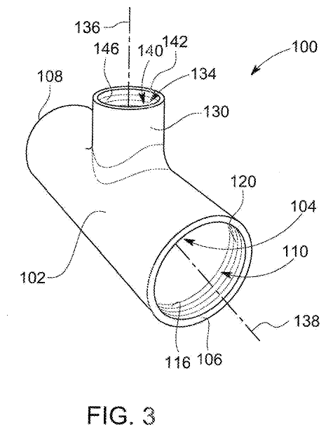

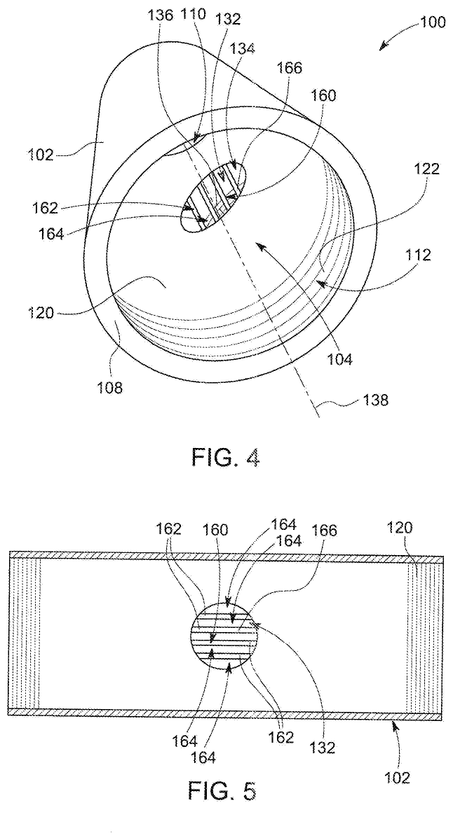

Referring to FIGS. 2, 3, and 4, a drain coupling 100 according to a presently preferred embodiment of the invention adapted to connect to two electrical conduits is shown. The drain coupling 100 is suitable to facilitate a drainage of condensate formed inside the electrical conduits and includes a tubular portion 102 defining an elongated channel 104 and having a first end 106 and a second end 108 arranged opposite to the first end 106. The first end 106 defines a first opening 110 (shown in FIG. 3) of the elongated channel 104, while the second end 108 defines a second opening 112 (shown in FIG. 4) of the elongated channel 104. It may be appreciated that a first electrical conduit (not shown) may be connected to the first end 106 of the tubular portion 102 and a second electrical conduit (not shown) may be connected to the second end 108 of tubular portion 102.

In one embodiment, to facilitate the attachment/connection of the first electrical conduit with the tubular portion 102, the tubular portion 102 may include first internal threads 116 (shown in FIG. 3) at the areas near the first end 106 of the tubular portion 102 and defined/formed along an inner surface 120 of the tubular portion 102. Similarly, the tubular portion 102 may further include second internal threads 122 (shown in FIG. 4) in the region near the second end 108 and defined/formed along the inner surface 120 of the tubular portion 102. In an alternative embodiment, the threads 116, 122 may be omitted, and in such case, the first electrical conduit may be attached the tubular portion 102 by inserting a portion of the first electrical conduit inside the elongated channel 104 through the first opening 110 and press fitting the portion of the first electrical conduit inside the tubular portion 102. Similarly, the second electrical conduit may be attached the tubular portion 102 by inserting a portion of the second electrical conduit inside the elongated channel 104 through the second opening 112 and press fitting the portion of the second electrical conduit inside the tubular portion 102. To enable a secure retention of the first electrical conduit and the second electrical conduit with the tubular portion 102, suitable adhesive may be utilized.

Further, the drain coupling 100 includes a drain tube 130 arranged substantially centrally to the tubular portion 102 and extending substantially perpendicularly to the tubular portion 102. The drain tube 130 defines an inlet opening 132 (shown in FIG. 4) at an interface of the tubular portion 102 with the drain tube 130. It may be appreciated that the inlet opening 132 facilitates a fluid connection of a drain passage 134 (shown in FIGS. 3 and 4) of the drain tube 130 with the elongated channel 104. A shown, a central axis 136 of the drain tube 130 (i.e., drain passage 134) is disposed substantially perpendicularly to a central axis 138 of the tubular portion 102 (i.e., elongate channel 104). Moreover, the drain passage 134 defines an outlet opening 140 (shown in FIG. 3) at a free end 142 of the drain tube 130. The outlet opening 140 facilitates an outlet of the condensate from the drain tube 130. To enable a connection of a breather plug 150 (shown in FIG. 2) with the drain tube 130, the drain tube 130 may include third internal threads 146 (best shown in FIG. 3) extending from the free end 142 of the drain tube 130 towards the inlet opening 132. The breather plug 150 may be inserted inside the drain tube 130 through the outlet opening 140 and is engaged with the drain tube 130 by engaging threads of the breather plug 150 with the third internal threads 146.

Referring to FIG. 4 and FIG. 5, to prevent the electrical cables/wires or fish tape, during installation, from entering inside the drain tube 130 through the inlet opening 132, the drain coupling 100 includes a guard 160 arranged inside the tubular portion 102 and partially covering the inlet opening 132 of the drain tube 130. As shown, the guard 160 includes a plurality of elongated strips 162 arranged spaced apart from each other and extending in a direction substantially parallel to the central axis 138 of the tubular portion 102. Accordingly, each elongated strip 162 extends along a length of the tubular portion 102. Further, the plurality of elongated strips 162 is arranged spaced apart from each other such an inlet groove 164 is defined between two adjacent strips 162. It may be appreciated that the strips 162 are arranged at the interface of the drain tube 130 with the tubular portion 102 and covering the inlet opening 132 such that an upper surface 166 of each strip 162 is flush with the adjacently arranged portion of the inner surface 120 of the tubular portion 102. A distance between two adjacent strips 162 is selected to prevent the electrical wires/fish tape from entering the drain tube 130 through the grooves 164, thereby preventing the electrical wires and/or the fish tape from getting stuck inside the drain tube 130 (i.e., the drain coupling 100) during installation of the electrical wires.

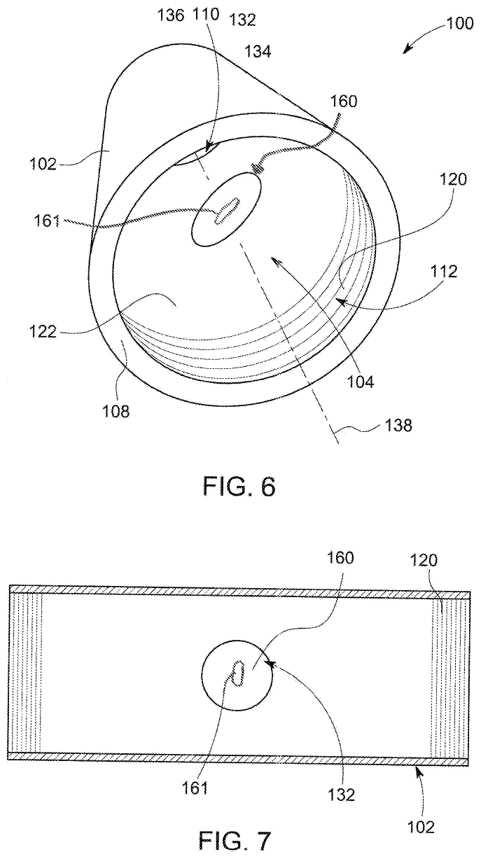

Referring to the alternative embodiment of the invention shown in FIG. 6 and FIG. 7, to prevent the electrical cables/wires or fish tape, during installation, from entering inside the drain tube 130 through the inlet opening 132, the drain coupling 100 includes a guard 160 arranged inside the tubular portion 102 and partially covering the inlet opening 132 of the drain tube 130. As shown, the guard 160 includes a single elongated hole 161 located near the center of the guard. The hole 161 is preferably a slot in the range of approximately ½ inch long by ¼ inch wide and is oriented perpendicular to the central axis 138 of the tubular portion 102 to prevent the electrical wires/fish tape from entering the drain tube 130 through the elongated hole 161, thereby preventing the electrical wires and/or the fish tape from getting stuck inside the drain tube 130 (i.e., the drain coupling 100) during installation of the electrical wires.

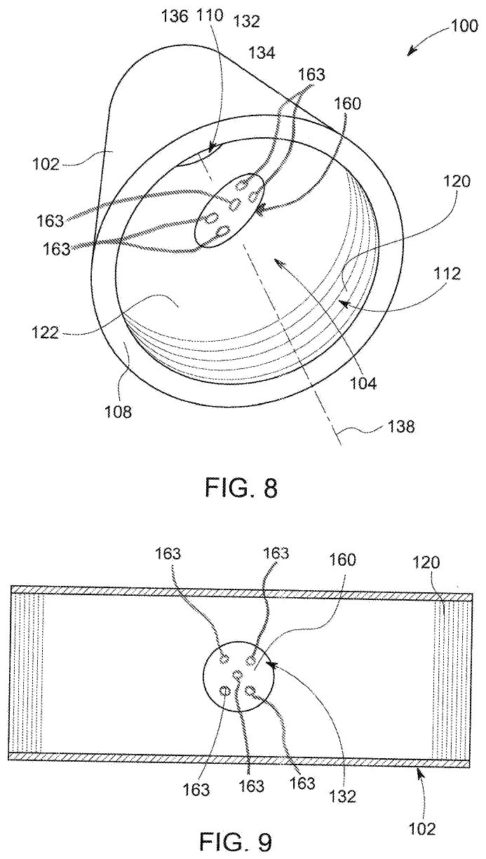

Referring to the further alternative embodiment of the invention shown in FIG. 8 and FIG. 9, to prevent the electrical cables/wires or fish tape, during installation, from entering inside the drain tube 130 through the inlet opening 132, the drain coupling 100 includes a guard 160 arranged inside the tubular portion 102 and partially covering the inlet opening 132 of the drain tube 130. As shown, the guard 160 includes a plurality of holes 163 in the guard 160. The holes 163 are preferably in the range of approximately ⅛ inch in diameter to prevent the electrical wires/fish tape from entering the drain tube 130 through the single hole 161, thereby preventing the electrical wires and/or the fish tape from getting stuck inside the drain tube 130 (i.e., the drain coupling 100) during installation of the electrical wires. While five (5) holes are shown in the further preferred embodiment, it within the scope of the invention to provide two or more such drain holes 163.

Accordingly, the drain coupling 100 facilitates the venting of gases generated inside the electrical conduits and drainage of the condensate, such as, water from the electrical conduits. The drain coupling 100 also provides an unobstructed pathway for the passage of electrical wires and/or fish tape. As the drain coupling 100 includes only two parts, the drain coupling 100 is easy to install relative to the existing condulet T-fittings 10 having 6 components.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

We claim:

1. A drain coupling adapted to connect to two electrical conduits to facilitate a drainage of condensate formed inside the electrical conduits comprising:
a. a tubular portion defining an elongated channel and having a first end defining a first opening adapted to connect to a first electrical conduit, and a second end arranged opposite to the first end and defining a second opening adapted to connect to a second electrical conduit;
b. a drain tube arranged substantially centrally to the tubular portion and extending substantially perpendicularly to the tubular portion, said drain tube having an inlet opening at an interface of the tubular portion and an outlet opening at a second free end of the drain tube, thereby facilitating a fluid connection of a drain passage of the drain tube with the elongated channel; and
c. a guard arranged inside the tubular portion and partially covering the inlet opening of the drain tube.

2. The drain coupling according to claim 1 wherein the guard is positioned at an interface of the drain tube with the tubular portion and covering the inlet opening.

3. The drain coupling according to claim 1 wherein the guard further comprises a plurality of elongated strips arranged spaced apart from each other and extending in a direction substantially parallel to a central axis of the tubular portion.

4. The drain coupling according to claim 3, wherein each elongated strip extends along a length of the tubular portion.

5. The drain coupling according to claim 3, wherein an inlet groove is positioned between each pair of adjacent elongated strips.

6. The drain coupling according to claim 5, wherein the strips are positioned at an interface of the drain tube with the tubular portion and cover the inlet opening.

7. The drain coupling according to claim 6, wherein an upper surface of each strip is flush with the adjacently arranged portion of the inner surface of the tubular portion.

8. The drain coupling according to claim 3, wherein a distance between adjacent strips is selected to prevent an electrical wire or fish tape from entering the drain tube through the grooves.

9. The drain coupling according to claim 2, wherein the guard comprises a hole located near the center of the guard.

10. The drain coupling according to claim 9, wherein the hole is preferably an elongated slot.

11. The drain coupling according to claim 10, wherein the elongated slot is approximately ½ inch long by ¼ inch wide.

12. The drain coupling according to claim 2, wherein the guard comprises a plurality of holes in the guard.

13. The drain coupling according to claim 12, wherein each of the plurality of holes is preferably in the range of approximately ⅛ inch in diameter.
